(19) United States
(12) Patent Application Publication
(10) Pub. No.: US 2026/0270383 A1
(43) Pub. Date: Sep. 10, 2026

(54) ELECTRONIC DEVICE AND STEREOSCOPIC IMAGE GENERATION METHOD THEREOF

(71) Applicant: ASUSTeK COMPUTER INC., Taipei City (TW)

(72) Inventor: Meng-Shan Lin, Taipei City (TW)

(73) Assignee: ASUSTeK COMPUTER INC., Taipei City (TW)

(21) Appl. No.: 19/555,892

(22) Filed: Mar. 4, 2026

(30) Foreign Application Priority Data
Mar. 7, 2025 (TW) 114108517

(51) Int. Cl. H04N 13/296; H04N 23/69

(52) U.S. Cl. CPC H04N 13/296; H04N 23/69

(57) ABSTRACT

An electronic device and a stereoscopic image generation method thereof are provided. The method is adapted to the electronic device including a first lens module and a second lens module and includes the following steps. A first image corresponding to a first viewpoint is generated by using the first lens module. An actual focus distance is obtained. A target zoom ratio of the second lens module is determined based on the actual focus distance. The maximum field of view (FOV) of the second lens module is greater than the maximum FOV of the first lens module. A second image corresponding to a second viewpoint is generated by using the second lens module according to the target zoom ratio. Stereoscopic image content is generated based on the first image and the second image.

### CROSS-REFERENCE TO RELATED APPLICATION

This application claims the priority benefit of Taiwan application serial no. 114108517, filed on Mar. 7, 2025. The entirety of the above-mentioned patent application is hereby incorporated by reference herein and made a part of this specification.

### BACKGROUND

### Technical Field

The disclosure is related to a stereoscopic image generation method and an electronic device using this method.

### Related Art

With the advancement of display technology, displays capable of supporting stereoscopic image playback have become increasingly widespread. The fundamental principle of stereoscopic display technology is to present a left-eye image to the viewer's left eye and a right-eye image to the viewer's right eye, thereby enabling the perception of stereoscopic visual effects. Based on this principle, dual-lens cameras capable of simultaneously capturing left-eye and right-eye images have emerged in the market, allowing for the generation of stereoscopic images or stereoscopic videos from such paired images. Currently, most professional dual-lens cameras available on the market employ two lens modules with identical specifications to simultaneously capture the left-eye and right-eye images. However, the high cost of these professional-grade dual-lens cameras makes them difficult for general consumers to access. As a result of their limited availability, the use of stereoscopic display devices remains restricted and has not been widely adopted in everyday life, making it difficult for users to enjoy a stable and immersive stereoscopic imaging experience.

### SUMMARY

The disclosure provides a stereoscopic image generation method, which is adapted to an electronic device including a first lens module and a second lens module, the method includes the following steps. A first image corresponding to a first viewpoint is generated by using the first lens module. An actual focal distance is obtained. A target zoom ratio of the second lens module is determined according to the actual focal distance, wherein the maximum field of view (FOV) of the second lens module is greater than the maximum field of view of the first lens module. A second image corresponding to a second viewpoint is generated by using the second lens module according to the target zoom ratio. A stereoscopic image content is generated according to the first image and the second image.

The disclosure also provides an electronic device, which includes a first lens module, a second lens module, and a processor. The processor is coupled to the first lens module and the second lens module. The processor is configured to execute the following operations. A first image corresponding to a first viewpoint is generated by using the first lens module. An actual focal distance is obtained. A target zoom ratio of the second lens module is determined according to the actual focal distance, wherein the maximum field of view (FOV) of the second lens module is greater than the maximum field of view of the first lens module. A second image corresponding to a second viewpoint is generated by using the second lens module according to the target zoom ratio. A stereoscopic image content is generated according to the first image and the second image.

Based on the above, in the embodiment of the disclosure, the target zoom ratio of the second lens module may be decided according to the actual focal distance such that the field of view used by the second lens module to generate the second image can be the same as the field of view used by the first lens module to generate the first image. According to two images corresponding to different viewpoints generated based on the same shooting field of view, a stereoscopic image content suitable for display on a stereoscopic display device may be generated. Accordingly, the disclosure enables the generation of high-quality stereoscopic image content using an electronic device equipped with lens modules of different specifications, without requiring professional stereoscopic camera equipment.

### BRIEF DESCRIPTION OF THE DRAWINGS

FIG. 1 is a block diagram of an electronic device illustrated according to an embodiment of the disclosure.

FIG. 2 is a schematic diagram of an electronic device illustrated according to an embodiment of the disclosure.

FIG. 3 is a flowchart of a stereoscopic image generation method illustrated according to an embodiment of the disclosure.

FIG. 4 is a schematic diagram of the first image and the second image corresponding to the same FOV illustrated according to an embodiment of the disclosure.

FIG. 5 is a flowchart of a stereoscopic image generation method illustrated according to an embodiment of the disclosure.

FIG. 6 is a flowchart of establishing a lookup table illustrated according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

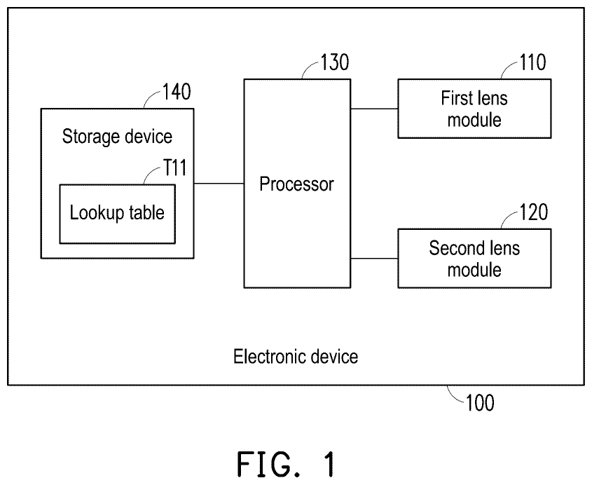

Referring to FIG. 1, the electronic device 100, for example, is a mobile electronic device with multiple lens modules such as a mobile phone or a tablet computer, etc., which is not limited by the disclosure. The electronic device 100 includes a first lens module 110, a second lens module 120, a processor 130, and a storage device 140.

The first lens module 110 comprises a first lens and a first image sensor. The second lens module 120 comprises a second lens and a second image sensor. In one embodiment, the photosensitive components of the first image sensor and the second image sensor are Charge Coupled Device (CCD), Complementary Metal-Oxide Semiconductor (CMOS) components or other components, which are not limited by the disclosure. In addition, the first lens module 110 and the second lens module 120 may each include an aperture and other components.

In some embodiments, the maximum field of view (FOV) of the second lens module 120 is greater than the maximum FOV of the first lens module 110. For example, the maximum FOV of the second lens module 120 may be approximately 120 degrees, and the maximum FOV of the first lens module 110 may be approximately 80 degrees. In some embodiments, the first lens module 110 comprises a regular wide-angle lens, and the second lens module 120 comprises an ultra-wide-angle lens. Alternatively, in other embodiments, the first lens module 110 comprises a telephoto lens, and the second lens module 120 comprises a regular wide-angle lens.

The storage device 140 is configured to store files, images, instructions, codes, software modules and other data, which may be, for example, any type of fixed or removable random access memory (RAM), read-only memory (ROM), flash memory, hard disk or other similar devices, integrated circuits or combinations thereof.

The processor 130 is coupled to the first lens module 110, the second lens module 120, and the storage device 140. In one embodiment, the processor 130 is a central processing unit (CPU), application processor (AP), or other programmable general-purpose or special-purpose microprocessor, digital signal processor (DSP), image signal processor (ISP), graphics processing unit (GPU) or other similar devices, integrated circuits or combinations thereof. In one embodiment, the processor 130 executes the code and software modules in the storage device 140 to implement various steps of the stereoscopic image generation method in the embodiments of the disclosure. The aforementioned software modules may be broadly interpreted to mean instructions, instruction sets, code, program code, programs, applications, software packages, threads, procedures, functions, etc., regardless of whether they are called software, firmware, middleware, microcode, hardware description language, or otherwise.

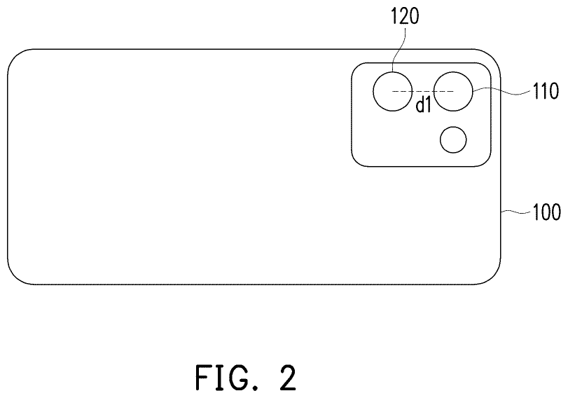

Referring to FIG. 2, which is a schematic diagram of an electronic device according to an embodiment of the disclosure. In one embodiment, the electronic device 100 is a smartphone with multiple lens modules. The shooting direction of the first lens module 110 of the electronic device 100 is the same as the shooting direction of the second lens module 120. The optical axis of the first lens module 110 is substantially parallel to the optical axis of the second lens module 120. When a user holds the electronic device 100 in a horizontal orientation, the first lens module 110 and the second lens module 120 are arranged horizontally, and the distance between them is d1. The first lens module 110 and the second lens module 120 may be configured to capture image content corresponding to different viewpoints.

In some embodiments, the first lens module 110 may be a main lens module that includes a wide-angle lens with optical zoom function. The second lens module 120 may be a fixed-focus lens module that includes an ultra-wide-angle lens.

In some embodiments, the image resolution of the first image sensor of the first lens module 110 is higher than the image resolution of the second image sensor of the second lens module 120.

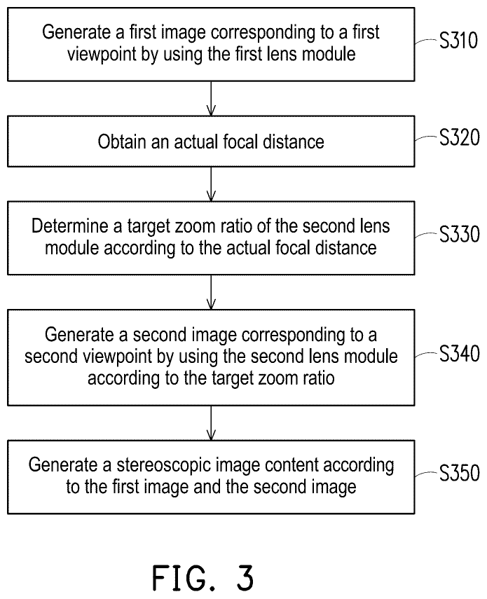

Referring to FIG. 3, which is a flowchart illustrating the stereoscopic image generation method according to the embodiment of the disclosure. The method of this embodiment may be executed by the electronic device 100 of FIG. 1, and the details of each step in FIG. 3 will be explained in conjunction with the components shown in FIG. 1.

At step S310, the processor 130 may generate a first image corresponding to a first viewpoint by using the first lens module 110. The lens of the first lens module 110 converges light to the first image sensor to generate the first image.

In some embodiments, the processor 130 may control the first lens module 110 to execute a focusing process (for example, auto-focusing (AF) process), to capture the first image while ensuring the target object is clear. The above shooting target object may be an object located at a preset position, a preset object (for example, a face), or an object manually designated by the user.

At step S320, the processor 130 may obtain an actual focus distance. The actual focus distance is the distance between the shooting target object and the first lens module 110, also known as the object distance.

In some embodiments, the processor 130 may obtain the actual focus distance using an active object distance measuring technique. For example, the processor 130 may utilize an infrared or ultrasonic sensor to emit a signal toward the target object and calculate the actual focus distance based on the time of flight of the reflected signal.

In some embodiments, the processor 130 may execute a focusing process by using the first lens module 110 to acquire the actual focus distance. The processor 130 may control the first lens module 110 to execute an auto-focusing (AF) process, to capture the first image and acquire the actual focus distance.

In some embodiments, the processor 130 may control the first lens module 110 to execute the AF process, and acquire the focus motor position of the first lens module 110, where the focus motor is configured to drive the lens of the first lens module 110. Afterwards, the processor 130 may acquire the corresponding actual focus distance by looking up a lookup table based on the focus motor position. Alternatively, in some embodiments, the processor 130 may control the first lens module 110 to perform an AF (auto-focusing) procedure and obtain the image distance, which refers to the distance from the optical center of the lens to the first image sensor. The processor 130 may then calculate the actual focus distance based on the focal length of the lens and the image distance, using an optical formula derived from lens imaging principles.

At step S330, the processor 130 may determine a target zoom ratio of the second lens module 120 according to the actual focus distance. The target zoom ratio may represent the scaling degree of the field of view (FOV) during image capture.

In some embodiments, the processor 130 may determine the target zoom ratio based on the actual focus distance and a preset function. That is, the processor 130 may calculate the target zoom ratio according to the actual focus distance and the preset function.

In some embodiments, the processor 130 may look up a lookup table T11 according to the actual focus distance, to acquire a target zoom ratio corresponding to the actual focus distance from the lookup table T11. The lookup table T11 may be stored in the storage device 140. The lookup table T11 may be configured to map the actual focus distance to one of multiple zoom ratios. In other words, the processor 130 may determine a target zoom ratio from multiple zoom ratios in the lookup table T11. In virous embodiments, the target zoom ratio may be one of the multiple zoom ratios in the lookup table T11, or the target zoom ratio may be an interpolation calculation result of two of the multiple zoom ratios in the lookup table T11.

At step S340, the processor 130 may generate a second image corresponding to the second viewpoint by using the second lens module 120 according to the target zoom ratio. In some embodiments, the processor 130 may control the second lens module 120 to perform digital zoom based on the target zoom ratio to generate the second image corresponding to the second viewpoint.

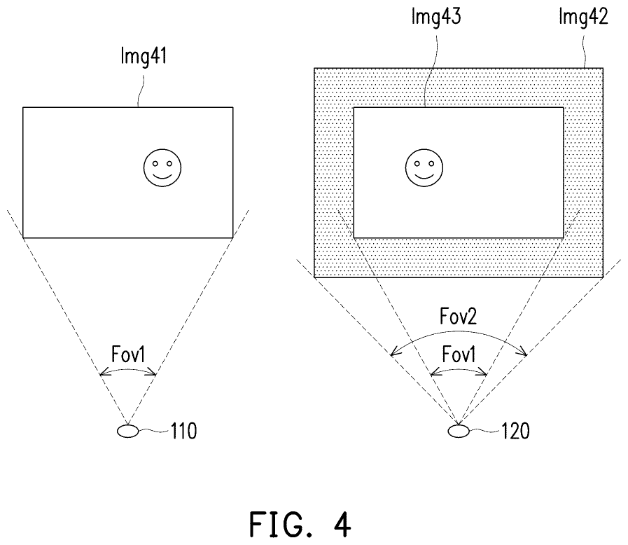

For example, referring to FIG. 4, which is a schematic diagram illustrating the first image and the second image corresponding to the same FOV according to the embodiment of the disclosure. The first lens module 110 may capture the first image Img41 according to the field of view Fov1. The second lens module 120 may capture the original image Img42 according to the original field of view Fov2. Thereafter, the processor 130 may perform a digital zoom operation on the original image Img42 based on the target zoom ratio, including a cropping process and an image scaling process, to obtain a second image Img43 corresponding to the field of view Fov1. The first image Img41 and the second image Img43 may serve as a left-eye image and a right-eye image, respectively, which exhibit horizontal disparity but no vertical disparity.

At step S350, the processor 130 may generate a stereoscopic image content according to the first image and the second image. Specifically, the processor 130 may generate a stereoscopic image content according to the first image corresponding to the first viewpoint and the second image corresponding to the second viewpoint. The first image and the second image may be left eye image and right eye image respectively. The stereoscopic image content may be displayed by a head-mounted display device (such as virtual reality device, augmented reality device or mixed reality device), naked-eye stereoscopic display device, or glasses-type stereoscopic display device, to provide the first image and the second image to the left eye and the right eye respectively, thereby allowing the viewer's left eye and right eye to view image content from different viewpoints and experience stereoscopic visual effects.

In some embodiments, the processor 130 may generate an image file that matches the stereoscopic file format according to the first image and the second image. The above-mentioned stereoscopic image file format is, for example, an image file format that stores the left eye image and the right eye image in separate layers, such as High Efficiency Image Coding (HEIC) format or Multiview-High Efficiency Video Coding (MV-HEVC) format, etc. Alternatively, the above-mentioned stereoscopic image file format is, for example, an image file format that includes Side-by-Side (SBS) images, such as Joint Photographic Experts Group (JPEG) format, Portable Network Graphics (PNG) format, or MP4 format, etc.

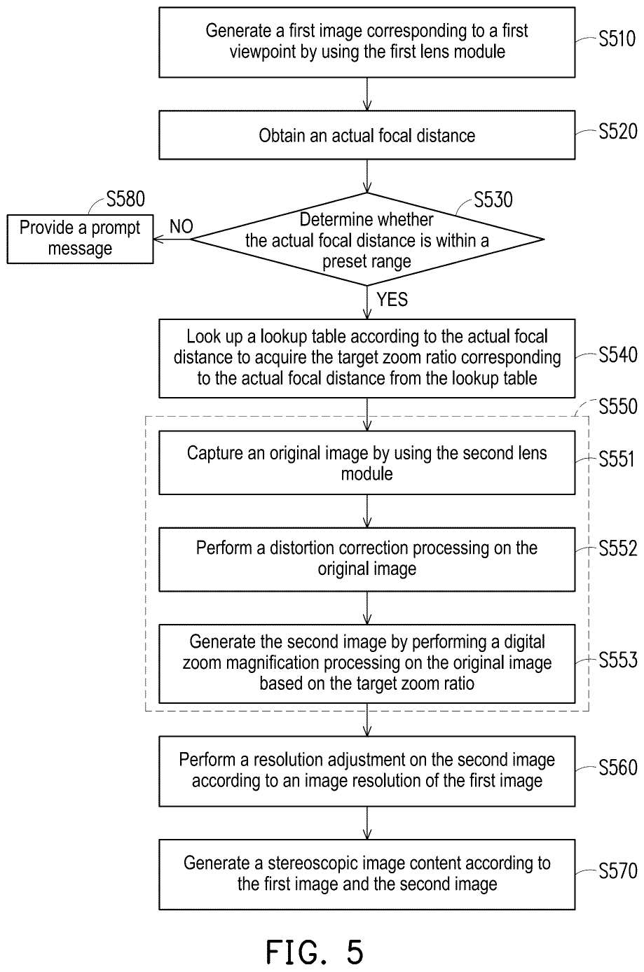

Referring to FIG. 5, which is a flowchart illustrating the stereoscopic image generation method according to the embodiment of the disclosure. The method of this embodiment may be executed by the electronic device 100 of FIG. 1, and the details of each step in FIG. 5 will be explained in conjunction with the components shown in FIG. 1.

At step S510, the processor 130 may generate the first image corresponding to the first viewpoint by using the first lens module 110. At step S520, the processor 130 may obtain an actual focal distance. The detailed implementation content of step S510 to step S520 may refer to the aforementioned embodiments, which will not be repeated here.

At step S530, the processor 130 may determine whether the actual focal distance is within a preset range. Specifically, when the actual focal distance is too small or too large, it will cause the parallax between the two images to be too large or too small, neither of which is suitable for generating stereoscopic image content with good stereoscopic visual perception. Therefore, when the actual focal distance is within the preset range, the processor 130 may determine the target zoom ratio of the second lens module 120 according to the actual focal distance, in order to proceed with the generation of stereoscopic image content based on the decision result of the target zoom ratio. Otherwise, when the actual focal distance is not within the preset range (the judgment at step S530 is negative), at step S580, the processor 130 may provide a prompt message to inform the user that the current shooting scenario is not suitable for generating stereoscopic image content.

In some embodiments, the processor 130 may determine whether the actual focal distance is greater than or equal to a minimum shooting distance, and determine whether the actual focal distance is less than or equal to a maximum shooting distance. When the actual focal distance is greater than or equal to a minimum shooting distance and less than or equal to a maximum shooting distance, then the actual focal distance is within the preset range. When the actual focal distance is less than a minimum shooting distance or greater than a maximum shooting distance, then the actual focal distance is not within the preset range.

At step S540, when the actual focal distance is within the preset range (the judgment at step S530 is positive), the processor 130 may look up a lookup table T11 according to the actual focal distance, to acquire the target zoom ratio corresponding to the actual focal distance from the lookup table T11.

In some embodiments, when the actual focal distance is within the first distance range, the target zoom ratio of the second lens module 120 is the first zoom ratio. When the actual focal distance is within the second distance range, the target zoom ratio of the second lens module 120 is the second zoom ratio. That is to say, the lookup table T11 may record multiple distance ranges. When the actual focal distance is within one of the multiple distance ranges, the processor 130 may decide the zoom ratio corresponding to that particular distance range as the target zoom ratio. For example, Table 1 is an example of the lookup table T11.

TABLE 1

| | |
|---|---|
| first distance range | Zoom ratio 1 |
| second distance range | Zoom ratio 2 |
| third distance range | Zoom ratio 3 |
| fourth distance range | Zoom ratio 4 |

Based on the example of Table 1, assuming the actual focal distance falls within the third distance range, then the processor 130 may decide the target zoom ratio to be Zoom ratio 3.

At step S550, the processor 130 may generate a second image corresponding to the second viewpoint by using the second lens module 120 according to the target zoom ratio. In some embodiments, step S550 may be implemented as steps S551 to S553.

At step S551, the processor 130 may capture a original image by using the second lens module 120. At step S552, before proceeding with a digital zoom magnification processing, the processor 130 may perform a distortion correction processing on the original image. By executing the distortion correction processing, the geometric deformation phenomenon caused by optical lens characteristics can be reduced. For example, when the second lens module 120 includes an ultra-wide-angle lens, the original image may cause bending or distortion of objects at the image edge due to barrel distortion. Through distortion correction processing, the processor 130 may correct such geometric deformations and restore the true proportions and linear features of objects in the image.

At step S553, the processor 130 may perform digital zoom magnification processing on the original image according to the target zoom ratio to generate the second image. Furthermore, the processor 130 may generate the second image by cropping and interpolating the original image, where the second image matches the target zoom requirements and may have higher image quality performance. Through image cropping in the digital zoom magnification processing, the field of view corresponding to the second image may be substantially identical to the field of view corresponding to the first image. Specifically, in the digital zoom process, the processor may select a smaller area (such as the center area of the image) from the second image for cropping, where this cropped area represents the field of view under the target zoom ratio. Then, the processor 130 enlarges the cropped image area to a specific output resolution through interpolation.

At step S560, the processor 130 may perform a resolution adjustment on the second image according to the image resolution of the first image. That is to say, the processor 130 may increase the image resolution of the second image to be the same as the image resolution of the first image.

At step S570, the processor 130 may generate a stereoscopic image content according to the first image and the second image. The detailed implementation content of step S570 may refer to the aforementioned embodiments, which will not be repeated here. When the electronic device 100 includes a stereoscopic display, the processor 130 may control this stereoscopic display to display the stereoscopic image content. Alternatively, the electronic device 100 may transmit the stereoscopic image content to a stereoscopic display device, for the stereoscopic display device to display the stereoscopic image content.

It should be explained that, when the second lens module 120 is equipped with an ultra-wide-angle lens, the image produced by the second lens module 120 may have distortion phenomena. The extent and severity of distortion caused by different object distances are different. Even after the processor 130 performs distortion correction processing for the second lens module 120, the corrected image will still retain some residual distortion. In addition, during the distortion correction processing, the processor 130 may also execute image edge cropping processing that causes the FOV to become smaller.” Therefore, when a fixed and single zoom ratio is used for the second lens module 120, it may not effectively compensate for image distortion caused by varying object distances, potentially resulting in mismatches between the second image and the first image captured by the first lens module 110 in terms of field of view or stereoscopic correspondence, thereby degrading the final stereoscopic visual effect. Accordingly, in the disclosure, a lookup table is used to determine the target zoom ratio based on the actual focus distance (i.e., the actual object distance), such that the second image generated based on the target zoom ratio can match the first image in terms of field of view and stereoscopic correspondence. The method for constructing the lookup table used to determine the target zoom ratio is described below.

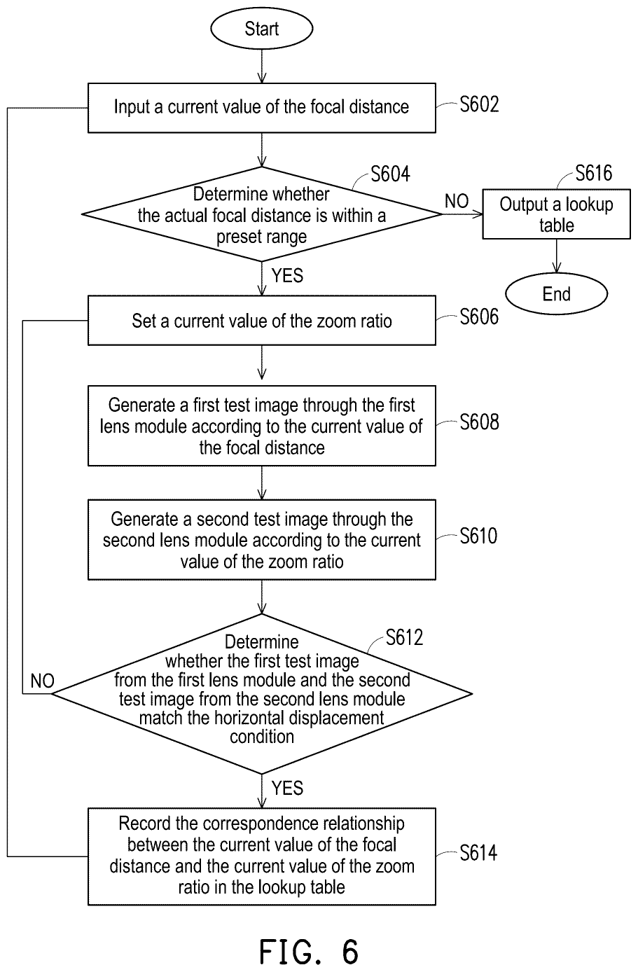

Referring to FIG. 6, which is a flowchart illustrating the establishment of a lookup table according to the embodiment of the disclosure. The lookup table configured to determine the target zoom ratio may be established according to the process shown in FIG. 6. It should be explained that each step shown in FIG. 6 may be executed by the electronic device 100 or by other computing devices. In some embodiments, when the lookup table is established by other computing devices, the electronic device 100 may receive and store the lookup table provided by other computing devices. This other computing device has camera modules with setup positions identical to the camera modules and their setup positions in the electronic device 100.

At step S602, the current value of the focal distance is inputted. For example, the initial value of the focal distance may be 0.4 m. With the repeated execution of steps S602 to S614 in FIG. 6, the current value of the focal distance may continuously increase and update to establish a lookup table that records different distance ranges.

At step S604, whether the focal distance is within a preset range is determined. In some embodiments, it may be determined whether the current value of the focal distance is less than or equal to the maximum shooting distance. The maximum shooting distance is, for example, 2 m, but is not limited to this.

When the judgment at step S604 is yes, the current value of the focal distance is less than or equal to the maximum shooting distance. At step S606, the current value of the zoom ratio is set. At step S608, a first test image is generated through the first lens module (for example, the first lens module 110 in FIG. 1) according to the current value of the focal distance. At step S610, a second test image is generated through the second lens module (for example, the second lens module 120 in FIG. 1) according to the current value of the zoom ratio.

At step S612, whether the first test image from the first lens module and the second test image from the second lens module match the horizontal displacement condition is determined. When there is horizontal disparity but no vertical disparity between the first test image and the second test image, it may be determined that the first test image and the second test image match the horizontal displacement condition. In some embodiments, it may be determined through human eye observation whether the first test image and the second test image have horizontal disparity but no vertical disparity. Alternatively, in some embodiments, image feature point extraction, feature point matching, and feature point coordinate comparison may be utilized to determine whether the first test image and the second test image have horizontal disparity but no vertical disparity.

When the judgment at step S612 is no, it means the first test image and the second test image do not match the horizontal displacement condition. When the first test image and the second test image do not match the horizontal displacement condition, return to step S606 to reset the current value of the zoom ratio, and execute steps S608 to S612 again.

When the judgment at step S612 is yes, the first test image and the second test image match the horizontal displacement condition. When the first test image and the second test image match the horizontal displacement condition, at step S614, the correspondence relationship between the current value of the focal distance and the current value of the zoom ratio is recorded in the lookup table.

Furthermore, when the judgment at step S604 is no, the current value of the focal distance has increased to be greater than the maximum shooting distance. Therefore, at step S616, the lookup table is outputted.

In summary, in the embodiments of the disclosure, the target zoom ratio of the second lens module may be decided according to the actual focal distance, so that the shooting field of view of the second lens module configured to generate the second image may be the same as the shooting field of view of the first lens module configured to generate the first image. According to two images corresponding to different viewpoints generated based on the same shooting field of view, stereoscopic image content suitable for display on a stereoscopic display device may be generated. Based on this, the disclosure may generate stereoscopic image content with good stereoscopic visual experience through an electronic device with different lens specifications. The disclosure significantly lowers the threshold for generating stereoscopic images, thereby enabling broader and more widespread application of related technologies. In addition, by establishing a lookup table to determine a suitable target zoom ratio based on the actual focus distance, images captured from different viewpoints can achieve more accurate matching in terms of field of view and stereoscopic correspondence.

It will be apparent to those skilled in the art that various modifications and variations can be made to the structure of the present invention without departing from the scope or spirit of the disclosure. In view of the foregoing, it is intended that the disclosure cover modifications and variations of this invention provided they fall within the scope of the following claims and their equivalents.

What is claimed is:

1. A stereoscopic image generation method, adapted to an electronic device comprising a first lens module and a second lens module, the method comprising:
generating a first image corresponding to a first viewpoint by using the first lens module;
obtaining an actual focal distance;
determining a target zoom ratio of the second lens module according to the actual focal distance, wherein the maximum field of view (FOV) of the second lens module is greater than the maximum field of view of the first lens module;
generating a second image corresponding to a second viewpoint by using the second lens module according to the target zoom ratio; and
generating a stereoscopic image content according to the first image and the second image.

2. The stereoscopic image generation method as claimed in claim 1, wherein the first lens module comprises a wide-angle lens, and the second lens module comprises an ultra-wide-angle lens.

3. The stereoscopic image generation method as claimed in claim 1, wherein the step of obtaining the actual focal distance comprises:
executing a focusing procedure by using the first lens module to acquire the actual focal distance.

4. The stereoscopic image generation method as claimed in claim 1, wherein the step of determining the target zoom ratio of the second lens module according to the actual focal distance comprises:
looking up a lookup table according to the actual focal distance to acquire the target zoom ratio corresponding to the actual focal distance from the lookup table.

5. The stereoscopic image generation method as claimed in claim 4, wherein when the actual focal distance is within a first distance range, the target zoom ratio of the second lens module is a first zoom ratio; and when the actual focal distance is within a second distance range, the target zoom ratio of the second lens module is a second zoom ratio.

6. The stereoscopic image generation method as claimed in claim 1, further comprising:
performing a resolution adjustment on the second image according to an image resolution of the first image.

7. The stereoscopic image generation method as claimed in claim 1, wherein the step of determining the target zoom ratio of the second lens module according to the actual focal distance comprises:
determining whether the actual focal distance is within a preset range; and
when the actual focal distance is within the preset range, determining the target zoom ratio of the second lens module according to the actual focal distance.

8. The stereoscopic image generation method as claimed in claim 1, wherein the step of generating the second image corresponding to the second viewpoint by using the second lens module according to the target zoom ratio to comprises:
capturing an original image by using the second lens module; and
generating the second image by performing a digital zoom magnification processing on the original image based on the target zoom ratio.

9. The stereoscopic image generation method as claimed in claim 8, wherein the step of generating the second image corresponding to the second viewpoint by using the second lens module according to the target zoom ratio further comprises:
performing a distortion correction processing on the original image before performing the digital zoom magnification processing.

10. An electronic device, comprising:
a first lens module;
a second lens module, wherein the maximum field of view of the second lens module is greater than the maximum field of view of the first lens module; and
a processor, coupled to the first lens module and the second lens module, and configured to:
generate a first image corresponding to a first viewpoint by using the first lens module;
obtain an actual focal distance;
determine a target zoom ratio of the second lens module according to the actual focal distance, wherein the maximum field of view (FOV) of the second lens module is greater than the maximum field of view of the first lens module;
generate a second image corresponding to a second viewpoint by using the second lens module according to the target zoom ratio; and
generate a stereoscopic image content according to the first image and the second image.
